(19) United States
(12) Patent Application Publication
(10) Pub. No.: US 2026/0202007 A1
(43) Pub. Date: Jul. 16, 2026

(54) WALL-MOUNTED HARDWARE MOUNTING BRACKET

(71) Applicant: Shenzhen Joyhong Tech Co.,Ltd, Shenzhen (CN)

(72) Inventor: Jianping Wang, Shenzhen (CN)

(21) Appl. No.: 19/561,979

(22) Filed: Mar. 10, 2026

(30) Foreign Application Priority Data
Feb. 11, 2026 (CN) 202620202659.3

(51) Int. Cl. F16M 13/02

(52) U.S. Cl. CPC F16M 13/02

(57) ABSTRACT

A wall-mounted hardware mounting bracket is provided, relating to the technical field of hardware mounting parts, and including a hardware bracket main body, where the hardware bracket main body is of a frame structure, an indication mark hole is provided in a top cross beam of the hardware bracket main body, outer sides of vertical beams on two sides of the hardware bracket main body are respectively connected to hooks, a bottom cross beam of the hardware bracket main body is provided with a horizontal part for mounting a magnetic level in a magnetic manner, and an interior of each opening is nested with a dumbbell-shaped silicone protective sleeve. The hardware bracket main body adopts the frame body, and the triangular indication mark hole is provided in the middle of the top cross beam, so that orientation calibration can be completed quickly, and a mounting offset is avoided.

### TECHNICAL FIELD

The present disclosure relates to the technical field of hardware mounting parts, and in particular, to a wall-mounted hardware mounting bracket.

### BACKGROUND

With popularization of smart home devices, devices that combine decorative and practical functions, such as smart photo frames, smart calendars, and e-books, have gradually become common products in home and office scenes. Such devices usually need to be fixed to walls through wall-mounted brackets to save space and enhance visual effects. However, the wall-mounted brackets in a conventional art generally have problems of poor mounting experience and insufficient adaptability: most brackets do not integrate a horizontal calibration structure, and require additional external level tools during mounting, which is cumbersome to operate and prone to horizontal deviation. Although some brackets are provided with hook structures, the hooks and bracket main bodies are mostly assembled separately, which results in insufficient structural strength, and is prone to looseness after long-term mounting. Moreover, there is no buffer protection structure on a surface of the hook, which is prone to scratching a device housing.

Meanwhile, a positioning mark of a conventional bracket is ambiguous, and it is difficult to quickly calibrate an orientation during mounting, resulting in an offset of a device after being mounted. Silicone protective sleeves are mostly of a flat adhesive type, which have poor connection stability with the bracket and are prone to detachment and failure. Moreover, a protective structure is not arranged for a contact position on the wall, which is prone to scratching a coating on the wall during mounting. In addition, fixed holes are mostly designed as ordinary through holes, and screw heads protrude after mounting and are prone to interfering with a back of the device, affecting fitness of the device. These defects not only reduce mounting efficiency, but also fail to effectively protect the device and the wall, making it is difficult to meet requirements on mounting convenience and safety of a user.

### SUMMARY

In view of disadvantages in a conventional art, the present disclosure provides a wall-mounted hardware mounting bracket, which solves problems proposed in the Background.

To achieve the above objective, the present disclosure provides the following technical solution: a wall-mounted hardware mounting bracket, including a hardware bracket main body, where the hardware bracket main body is of a frame structure, an indication mark hole is provided in a top cross beam of the hardware bracket main body, outer sides of vertical beams on two sides of the hardware bracket main body are respectively connected to hooks, a plurality of fixed holes are provided in a horizontal mounting surface on a back of the hardware bracket main body, a bottom cross beam of the hardware bracket main body is provided with a horizontal part for mounting a magnetic level in a magnetic manner, a plurality of openings are provided in inner folded surfaces of the vertical beams on the two sides of the hardware bracket main body, and an interior of each opening is nested with a dumbbell-shaped silicone protective sleeve.

As a preference of the present disclosure, the indication mark hole is a triangular mark hole, and the indication mark hole is provided at a middle position of the top cross beam of the hardware bracket main body.

As a preference of the present disclosure, the hooks are symmetrically arranged at tops and bottoms of the vertical beams of the two sides of the hardware bracket main body.

As a preference of the present disclosure, the fixed holes are counterbores, which are respectively provided at positions of four corners of the back of the hardware bracket main body.

As a preference of the present disclosure, the magnetic level is detachably mounted on the bottom cross beam of the hardware bracket main body in a magnetic manner.

As a preference of the present disclosure, a silicone pad is bonded to one side of the hardware bracket main body close to the mounting surface.

As a preference of the present disclosure, the hardware bracket main body and the hooks are integrally formed, and an arc-shaped hook groove is provided in an inner side of a hook body of the hook.

Compared with the conventional art, the present disclosure has the following beneficial effects:

The present disclosure provides a wall-mounted hardware mounting bracket:

1. The hardware bracket main body of the present disclosure adopts the frame body, and the triangular indication mark hole is provided in the middle of the top cross beam, so that orientation calibration can be completed quickly, and a mounting offset is avoided. The integrally formed hooks symmetrically arranged on the vertical beams on the two sides can improve mounting stability and prevent a device from slipping, do not require additional assembly, and improve structural strength. The detachable level is mounted on the horizontal part of the bottom cross beam in a magnetic manner, which can quickly complete levelness adjustment without the help of an external tool, and greatly improve mounting efficiency. The dumbbell-shaped silicone protective sleeves are nested into the openings in the inner folded holes of the vertical beams, connection stability is stronger, contact collision between the device and the bracket can be buffered effectively, and wear of a device housing is avoided.

2. According to the present disclosure, screw heads can completely sink into the bracket through countersunk head fixed holes at four corners, thereby avoiding interfering with a back of the device, and ensuring close fit between the device and the bracket, the silicone pad bonded to one side close to the mounting surface can effectively buffer a contact pressure between the bracket and the wall, and prevent a coating on the wall from being scratched; and magnetic level can be disassembled and recycled after mounting is completed, thereby achieving reuse, and effectively ensuring practicability of the wall-mounted hardware mounting bracket.

### BRIEF DESCRIPTION OF THE DRAWINGS

FIG. 1 is a schematic structural diagram of the present disclosure;

FIG. 2 is one of schematic structural diagrams of the present disclosure;

FIG. 3 is an exploded view of the present disclosure; and

FIG. 4 is a schematic structural diagram of a silicone pad of the present disclosure.

In the drawings: 100, hardware bracket main body; 110, indication mark hole; 120, hook; 130, fixed hole; 140, horizontal part; 150, opening; 200, magnetic level; 300, silicone protective sleeve; and 400, silicone pad.

### DETAILED DESCRIPTION OF THE EMBODIMENTS

Technical solutions in embodiments of the present disclosure will be clearly and completely described herein below with reference to accompanying drawings in the embodiments of the present disclosure. Apparently, the described embodiments are merely part rather than all embodiments of the present disclosure. Based on the embodiments in the present disclosure, all other embodiments obtained by those of ordinary skill in the art without creative work fall within the scope of protection of the present disclosure.

Terms such as "first" and ''second" in specification and claims in the embodiments of the present disclosure are used for distinguishing similar objects instead of describing a specific order or sequence. It is to be understood that data used in this way are exchangeable in a proper case, so that the embodiments of the present disclosure can be implemented in a sequence other than sequences graphically shown or described here, and objects distinguished by "first" and "second" are usually of the same class without limiting a quantity of the objects, for example, a first object may be one or more. In addition, "and/or" in the specification and the claims represents at least one of the connected objects, and character "/" generally represents that contextual objects are in an "or" relationship.

In the description of the present disclosure, it is to be understood that orientation or position relationships indicated by terms such as "center", "upper", "lower", "front", "rear", "left", "right", "vertical", "horizontal", "top", "bottom", "inner", and "outer" are based on orientation or position relationships shown in the accompanying drawings, and are used for facilitating describing the present disclosure and simplifying the description, rather than indicating or implying that the apparatus or element referred to has to have a particular orientation or has to be constructed and operated in a particular orientation. Therefore, such terms cannot be construed as a limitation to the present disclosure.

In the description of the present disclosure, it is to be noted that, unless otherwise specified and defined explicitly, terms "mount", "connect", and "arrange" are to be broadly understood. For example, the terms may refer to fixed connection and arrangement, or may refer to detachable connection or arrangement, or integrated connection or arrangement. Those of ordinary skill in the art may understand specific meanings of the foregoing terms in the present disclosure in specific cases.

### Embodiment

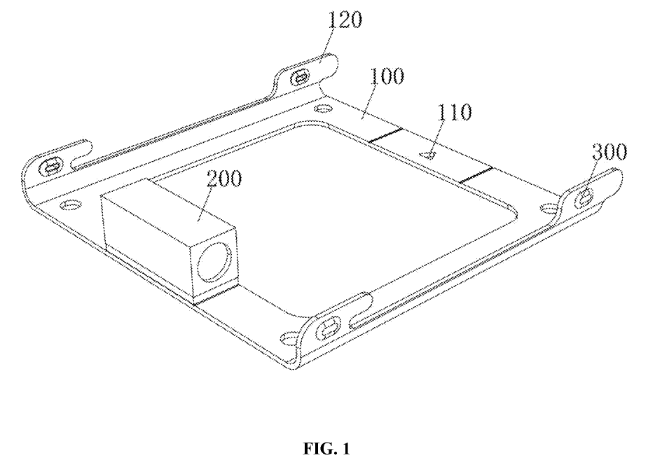

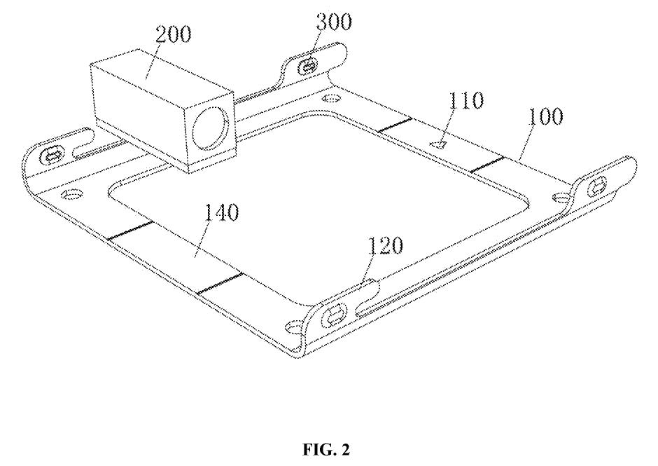

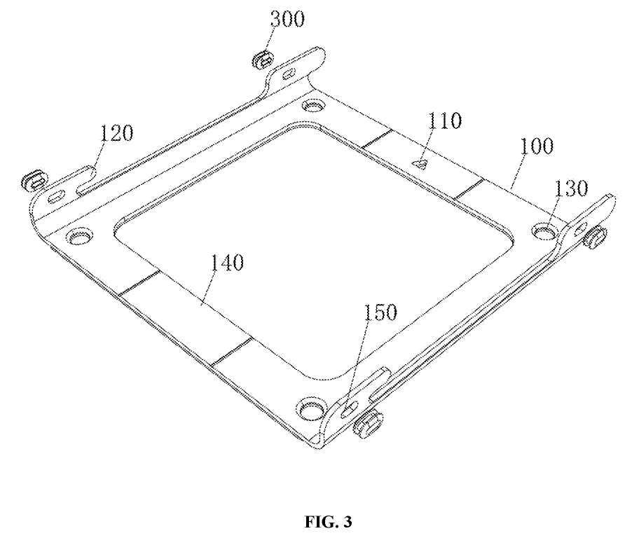

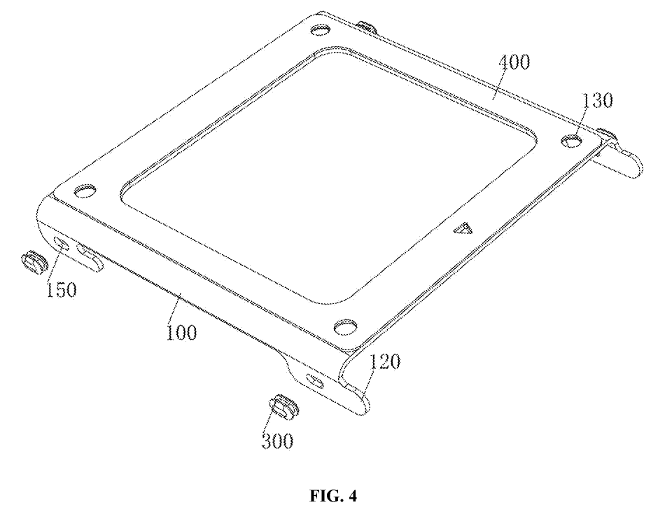

As shown in FIG. 1 to FIG. 4, a wall-mounted hardware mounting bracket provided by the present disclosure includes a hardware bracket main body 100, where the hardware bracket main body 100 is of a frame structure, an indication mark hole 110 is provided in a top cross beam of the hardware bracket main body 100, outer sides of vertical beams on two sides of the hardware bracket main body 100 are respectively connected to hooks 120, a plurality of fixed holes 130 are provided in a horizontal mounting surface on a back of the hardware bracket main body 100, a bottom cross beam of the hardware bracket main body 100 is provided with a horizontal part 140 for mounting a magnetic level 200 in a magnetic manner, a plurality of openings 150 are provided in inner folded surfaces of the vertical beams on the two sides of the hardware bracket main body 100, and an interior of each opening 150 is nested with a dumbbell-shaped silicone protective sleeve 300.

Specifically, when the hardware bracket is mounted, a user first fits the hardware bracket main body 100 to a wall, and is quickly aligned a positioning baseline preset on the wall through indication mark hole 110 in the middle of the top cross beam, so as to complete preliminary orientation calibration; and subsequently, the hardware bracket main body 100 is preliminarily fixed to the wall by driving screws by using the fixed holes 130 at four corners of a horizontal mounting surface on the back. In this case, the horizontal part 140 of the bottom cross beam may adsorb the magnetic level 200, and the user finely adjusts a mounting angle of the hardware bracket main body 100 by observing a position of an air bubble of the magnetic level 200, thereby ensuring that a whole body is in a horizontal state. After horizontal calibration is completed, the screws in the fixed holes 130 are screwed to complete final fixation.

When a smart photo frame, a smart calendar, or an e-book is mounted, hanging points on the back of the device are embedded into the hooks 120 on the outer sides of the vertical beams on the two sides. In this case, the dumbbell-shaped silicone protective sleeves 300 nested in the openings 150 in the inner folded surfaces of the vertical beams are in contact with a side surface of the device to buffer a collision pressure between the device and the hardware bracket main body 100 through self-elasticity. Meanwhile, a dumbbell-shaped structural design can further prevent the dumbbell-shaped silicone protective sleeves 300 from being detached from the openings 150, thereby maintaining a protective effect continuously.

In this embodiment: the indication mark hole 110 is a triangular mark hole, and the indication mark hole 110 is provided at a middle position of the top cross beam of the hardware bracket main body 100.

Specifically, at an initial mounting stage of the hardware bracket, the user may align the triangular indication mark hole 110 with a vertical baseline that is pre-marked on the wall to quickly determine a central orientation of the hardware bracket main body 100, thereby avoiding a left-right offset of a subsequently mounted device caused by positioning deviation. After the indication mark hole 110 is aligned with the baseline, the hooks 120 symmetrically arranged on the two sides are positioned in the same vertical plane naturally, thereby ensuring that the device does not tilt on one side after being mounted. Meanwhile, the triangular indication mark hole 110 forms complementary positioning with the magnetic level 200 at the bottom. The user may first complete coarse positioning in a vertical direction through the indication mark hole 110, and then complete fine adjustment in a horizontal direction through the magnetic level 200, so that mounting accuracy is significantly improved through a dual calibration mechanism, and problems of positioning ambiguity and a mounting offset of the conventional bracket are solved.

In this embodiment: the hooks 120 are symmetrically arranged at tops and bottoms of the vertical beams of the two sides of the hardware bracket main body 100.

Specifically, when the device is mounted, mounting points on the back are embedded into the arc-shaped hook grooves of the hooks 120. An arc-shaped structure may increase contact area between the mounting point and the hook 120, thereby increasing frictional force, and preventing the device from detaching. Meanwhile, an integrally formed structure of the hook 120 and the hardware bracket main body 100 further enhances bearing strength, and avoids a defect that a split hook is prone to looseness. Meanwhile, the upper and lower symmetrical hooks 120 cooperate a protective effect of the silicone protective sleeves 300, so that the device is maintained in a stable mounted state all the time, and cannot displace or detach even being slightly impacted by an external force.

In this embodiment: the fixed holes 130 are counterbores, which are respectively provided at positions of four corners of the back of the hardware bracket main body 100.

Specifically, when the user drives the screws to complete fixation, screw heads completely sink into the counterbores and do not protrude from the mounting surface of the hardware bracket main body 100, thereby avoiding interfering with the back of the device, and ensuring that the device can be in close fit with the hardware bracket main body 100. Moreover, a layout of the four corners enables stress of the hardware bracket main body 100 to be uniformly distributed at four support points of the wall, which improves mounting stability, and prevents the bracket from tilting or loosening after long-term mounting.

In this embodiment: the magnetic level 200 is detachably mounted on the bottom cross beam of the hardware bracket main body 100 in a magnetic manner.

Specifically, at an initial mounting stage, the user may directly adsorb the magnetic level 200 to the horizontal part 140 to quickly complete levelness detection without an additional tool. When the hardware bracket main body 100 is not in a horizontal state, an air bubble in the magnetic level 200 deviates from a central position. The user finely adjusts a mounting angle of the bracket to enable the air bubble to return to a center, so as to enable the hardware bracket main body 100 to be in the horizontal state and then to cooperate with the indication mark hole 110, thereby completing positioning in the vertical direction first through the indication mark hole 110 and then completing calibration in the horizontal direction through the magnetic level 200. Mounting accuracy is significantly improved through a dual calibration mechanism. After mounting is completed, the user may take the magnetic level 200 from the horizontal part 140, thereby achieving reuse, and reducing mounting costs. A magnetic connection manner facilitates assembling and disassembling of the level, an additional fixing structure is not required, and an operation process is simplified.

In this embodiment: a silicone pad 400 is bonded to one side of the hardware bracket main body 100 close to the mounting surface.

Specifically, the silicone pad 400 is bonded to one side of the hardware bracket main body 100 close to the mounting surface, and is in direct contact with the wall during mounting, so as to buffer a collision pressure between the hardware bracket main body 100 and the wall through self-elasticity, and effectively prevent a coating on the wall from being scratched. In addition, a frictional force of the silicone pad 400 may further enhance fitness between the hardware bracket main body 100 and the wall, and avoids displacement of the bracket during mounting or use.

When the user screws the screw in the fixed hole 130, the silicone pad 400 is compressed to fill a tiny gap between the wall and the hardware bracket main body 100, so that the bracket fits the wall more stably, thereby reducing shaking caused by an uneven wall. A protective effect of the silicone pad 400 forms a dual protective system with the dumbbell-shaped silicone protective sleeve 300, which effectively avoids damage to the wall and the device during a full process from mounting to use, and improves use experience and reliability of a product while protecting the wall and the device.

In this embodiment: the hardware bracket main body 100 and the hooks 120 are integrally formed, and an arc-shaped hook groove is provided in an inner side of a hook body of the hook 120.

Specifically, the hardware bracket main body 100 and the hook 120 are manufactured by an integrated forming process, which can significantly improve bearing strength of the hook 120, and avoids a risk of device detachment caused by loose assembly of a split hook. An arc-shaped hook groove design on an inner side of the hook 120 can be in perfect fit with the mounting point on the back of the device, thereby increasing frictional force while increasing contact area, and preventing the device from slipping in a mounting process.

Embodiments of the present disclosure have been described above with reference to accompanying drawings. However, the present disclosure is not limited to the foregoing specific implementations. The foregoing specific embodiments are merely examples rather than restrictions. Those of ordinary skill in the art may make many forms under the teaching of the present disclosure without departing from the spirit of the present disclosure and the scope of protection of claims, which all fall within the scope of protection of the present disclosure.

What is claimed is:

1. A wall-mounted hardware mounting bracket, comprising a hardware bracket main body (100), wherein the hardware bracket main body (100) is of a frame structure, an indication mark hole (110) is provided in a top cross beam of the hardware bracket main body (100), outer sides of vertical beams on two sides of the hardware bracket main body (100) are respectively connected to hooks (120), a plurality of fixed holes (130) are provided in a horizontal mounting surface on a back of the hardware bracket main body (100), a bottom cross beam of the hardware bracket main body (100) is provided with a horizontal part (140) for mounting a magnetic level (200) in a magnetic manner, a plurality of openings (150) are provided in inner folded surfaces of the vertical beams on the two sides of the hardware bracket main body (100), and an interior of each opening (150) is nested with a dumbbell-shaped silicone protective sleeve (300).

2. The wall-mounted hardware mounting bracket according to claim 1, wherein the indication mark hole (110) is a triangular mark hole, and the indication mark hole (110) is provided at a middle position of the top cross beam of the hardware bracket main body (100).

3. The wall-mounted hardware mounting bracket according to claim 1, wherein the hooks (120) are symmetrically arranged at tops and bottoms of the vertical beams of the two sides of the hardware bracket main body (100).

4. The wall-mounted hardware mounting bracket according to claim 1, wherein the fixed holes (130) are counterbores, which are respectively provided at positions of four corners of the back of the hardware bracket main body (100).

5. The wall-mounted hardware mounting bracket according to claim 1, wherein the magnetic level (200) is detachably mounted on the bottom cross beam of the hardware bracket main body (100) in a magnetic manner.

6. The wall-mounted hardware mounting bracket according to claim 1, wherein a silicone pad (400) is bonded to one side of the hardware bracket main body (100) close to the mounting surface.

7. The wall-mounted hardware mounting bracket according to claim 1, wherein the hardware bracket main body (100) and the hooks (120) are integrally formed, and an arc-shaped hook groove is provided in an inner side of a hook body of the hook (120).
